(19) United States
(12) Patent Application Publication
(10) Pub. No.: US 2020/0180200 A1
(43) Pub. Date: Jun. 11, 2020

(54) INJECTION MOLDING APPARATUS AND INJECTION MOLDING METHOD

(71) Applicant: Chung Yuan Christian University, Taoyuan City (TW)

(72) Inventors: Shia-Chung Chen, Taoyuan City (TW); Yung-Hsiang Chang, Taoyuan City (TW); Kuan-Hua Lee, Taoyuan City (TW); Che-Wei Chang, Taoyuan City (TW); Pi-Lin Tsai, Taoyuan City (TW)

(73) Assignee: Chung Yuan Christian University, Taoyuan City (TW)

(21) Appl. No.: 16/503,647

(22) Filed: Jul. 5, 2019

(30) Foreign Application Priority Data
Dec. 5, 2018 (TW) 107143654

(51) Int. Cl. B29C 45/56; B29C 45/00; B29C 45/17

(52) U.S. Cl. CPC B29C 45/56; B29C 45/174; B29C 45/0025

(57) ABSTRACT

An injection molding apparatus including a mold and an injection device is provided. The mold includes a fixed portion and a movable portion. A molding concavity is formed between the fixed portion and the movable portion, and the movable portion is adapted to move relative to the fixed portion to change a volume of the molding cavity, so that a pressure inside the molding concavity is adjusted between a pressurized state and a non-pressurized state. The injection device is adapted to inject a material into the molding concavity. The material includes a supercritical fluid, the supercritical fluid is prevented from being gasified in the pressurized state, and the supercritical fluid is gasified in the non-pressurized state. In addition, an injection molding method is also provided.

### CROSS-REFERENCE TO RELATED APPLICATION

This application claims the priority benefit of Taiwan application serial no. 107143654, filed on Dec. 5, 2018. The entirety of the above-mentioned patent application is hereby incorporated by reference herein and made a part of this specification.

### BACKGROUND OF THE INVENTION

### 1. Field of the Invention

The invention relates to a molding apparatus and a molding method, and particularly relates to an injection molding apparatus and an injection molding method.

### 2. Description of Related Art

Owing to the foaming properties, the products manufactured through the supercritical foaming technology exhibit properties such as a high weight loss ratio, high impact strength, and high elasticity, etc., and have therefore been applied to various fields. However, also due to the foaming properties, the product is prone to have defects on the surface. Besides, because of the difficulty in controlling bubbles in the interior of the product, a large bubble may be generated easily, and the mechanical properties of the product may be affected. As a result, the product quality and yield are lower than expected.

### SUMMARY OF THE INVENTION

The embodiments of the invention provide an injection molding apparatus and an injection molding method capable of manufacturing products with a desirable quality and yield by adopting the supercritical foaming technology.

According to an embodiment of the invention, a injection molding apparatus includes a mold and an injection device. The mold includes a fixed portion and a movable portion. A molding concavity is formed between the fixed portion and the movable portion, and the movable portion is adapted to move relative to the fixed portion to change a volume of the molding cavity, so that a pressure inside the molding concavity is adjusted between a pressurized state and a non-pressurized state. The injection device is adapted to inject a material into the molding concavity. The material includes a supercritical fluid, the supercritical fluid is prevented from being gasified in the pressurized state, and the supercritical fluid is gasified in the non-pressurized state.

According to an embodiment of the invention, the injection molding apparatus further includes a gas supply device. The gas supply device is adapted to supply a gas into the molding cavity to increase the pressure inside the molding cavity.

According to an embodiment of the invention, the mold has a gas injection passage, the gas injection passage connects interior of the molding cavity and exterior of the molding cavity, and the gas supply device is adapted to supply the gas into the molding cavity via the gas injection passage.

According to an embodiment of the invention, the injection molding apparatus further includes a pressure sensor. The pressure sensor is disposed to the gas injection passage.

According to an embodiment of the invention, an injection molding method includes the following. A mold is provided. The mold includes a fixed portion and a movable portion, and a molding cavity is formed between the fixed portion and the movable portion. The movable portion is moved relative to the fixed portion to reduce a volume of the molding cavity, so that a pressure inside the molding cavity is adjusted from a non-pressurized state to a pressurized state. A material is injected into the molding cavity by an injection device. The material includes a supercritical fluid, and the supercritical fluid is prevented from being gasified in the pressurized state. The movable portion is moved relative to the fixed portion to increase the volume of the molding cavity, so as to restore the pressure inside the molding cavity to the non-pressurized state. The supercritical fluid is gasified in the non-pressurized state.

According to an embodiment of the invention, the injection molding method further includes supplying a gas into the molding cavity by a gas supply device to increase the pressure inside the molding cavity.

According to an embodiment of the invention, after the gas is supplied into the molding cavity of the mold, the material is injected into the molding cavity by the injection device.

According to an embodiment of the invention, after a predetermined period of time following injection of the material into the molding cavity by the injection device, the gas supply device stops supplying the gas.

According to an embodiment of the invention, after the movable portion is moved relative to the fixed portion to reduce the volume of the molding cavity, the material is injected into the molding cavity by the injection apparatus.

According to an embodiment of the invention, after a predetermined period of time following injection of the material into the molding cavity by the injection device, the movable portion is moved relative to the fixed portion to increase the volume of the molding cavity.

Based on the above, in the embodiments of the invention, before the raw material is injected into the mold, the movable portion of the mold is moved to increase the pressure inside the molding cavity. In this way, the supercritical fluid in the material injected into the mold is prevented from foaming. After the surface of the raw material injected into the mold is cooled off and solidified, the movable portion of the mold is moved to reduce the pressure inside the molding cavity, so that the supercritical fluid in the raw material starts foaming as the pressure decreases. In this way, a defect generated on the surface of the raw material in a non-solidified state due to foaming of the supercritical fluid is avoided, and the foaming of the supercritical fluid is uniform. Thus, the products manufactured accordingly have a desirable quality and yield.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an injection molding apparatus according to an embodiment of the invention.

FIGS. 2A to 2D are views illustrating an operational process of an injection molding apparatus 100 of FIG. 1.

FIG. 3A and FIG. 3B are views illustrating an operational process of an injection molding apparatus according to another embodiment of the invention.

FIG. 4 is a flowchart illustrating an injection molding method of the injection molding apparatus of FIGS. 3A and 3B.

FIG. 5A and FIG. 5B are views illustrating an operational process of an injection molding apparatus according to another embodiment of the invention.

FIG. 6 is a flowchart illustrating an injection molding method of the injection molding apparatus of FIGS. 5A and 5B.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

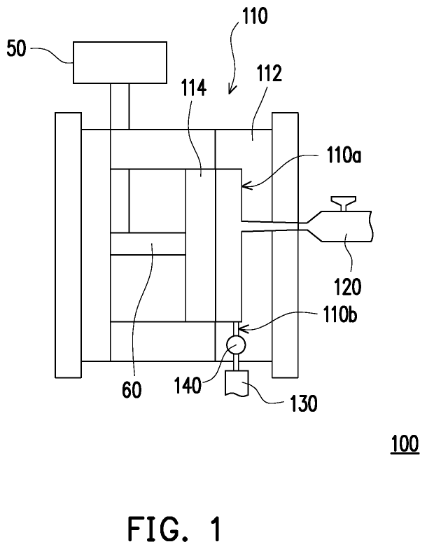

FIG. 1 is a schematic view illustrating an injection molding apparatus according to an embodiment of the invention. Referring to FIG. 1, an injection molding apparatus 100 of this embodiment includes a mold 110, an injection device 120, and a gas supply device 130. The mold 110 includes a fixed portion 112 and a movable portion 114. A molding cavity 110a is formed between the fixed portion 112 and the movable portion 114. The movable portion 114 is adapted to move relative to the fixed portion 112 to change a volume of the molding cavity 110a.

The mold 110 has a gas injection passage 110b. The gas injection passage 11b connects the interior of the molding cavity 110a and the exterior of the molding cavity 110a. The gas supply device 130 is adapted to supply a gas into the molding cavity 110a via the gas injection passage 110b. The gas may be supplied into the molding cavity 110a by adopting the gas counter pressure technology, for example, and the gas may be an inert gas. The injection molding apparatus 100 further includes a pressure sensor 140. The pressure sensor 140 is disposed to the gas injection passage 110b and may be adapted to sense a pressure when the gas is injected into the molding cavity 110a, so as to control an injection pressure when the gas supply device 130 injects the gas into the molding cavity 110a.

Based on the position to which the movable portion 114 is moved and whether the gas supply device 130 supplies the gas into the molding cavity 110a, the pressure inside the molding cavity 110a can be adjusted between a non-pressurized state and a pressurized state. The injection device 120 is adapted to inject a material M into the molding cavity. The material M is a plastic material, for example, and includes a supercritical fluid, so as to foam through gasification of the supercritical fluid in the material M. The supercritical fluid is prevented from being gasified in the pressurized state, and the supercritical fluid is gasified in the non-pressurized state. The supercritical fluid is manufactured by pressurizing gaseous nitrogen or an inert gas, for example, and is mixed with a plastic material at the injection device 120 to form the material M.

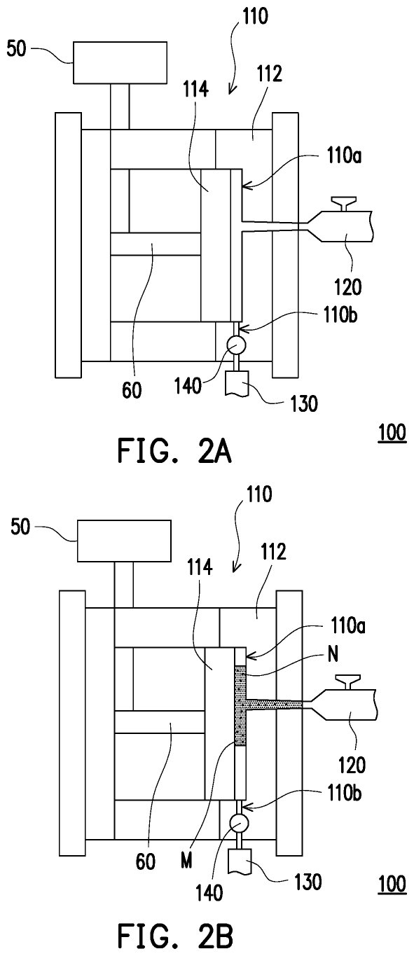

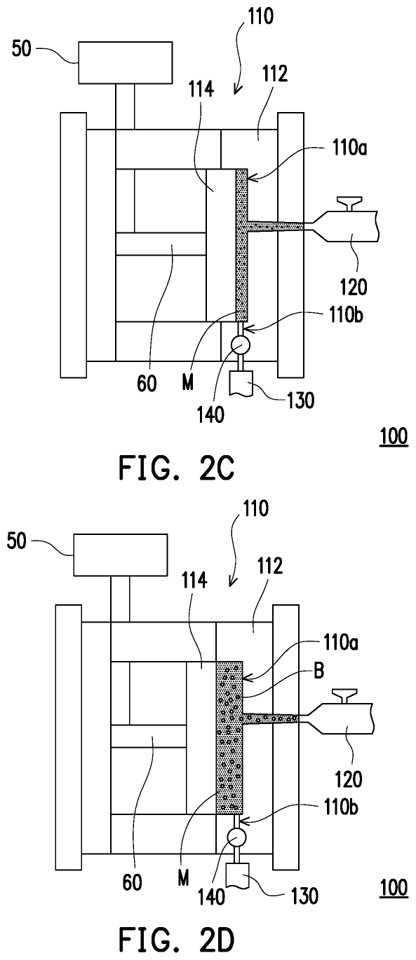

FIGS. 2A to 2D are views illustrating an operational process of an injection molding apparatus 100 of FIG. 1. Specifically, before an injection molding process, a control unit 50 may control a driving mechanism 60 to drive the movable portion 114 of FIG. 1 to the position shown in FIG. 2A by the driving mechanism 60, so that the volume of the molding cavity 110a is reduced and the pressure inside the molding cavity 110a is increased. Also, the pressure inside the molding cavity 110a is increased by supplying the gas by the gas supply device 130. Accordingly, the pressure inside the molding cavity 110a is adjusted from the non-pressurized state shown in FIG. 1 to the pressurized state shown in FIG. 2A. The control unit 50 is, for example, a computer or other control devices controllable by the user, and the driving mechanism 60 is, for example, a linking rod or other suitable mechanisms driven by a motor, a cylinder, or other suitable driving sources. It should be noted that the invention does not intend to impose a limitation on this regard.

After the movable portion 114 is moved relative to the fixed portion 112 to reduce the volume of the molding cavity 110a and the gas is supplied into the molding cavity 110a by the gas supply device 130, the material M is injected into the molding cavity 110a by the injection device 120, as shown in FIGS. 2B to 2C. At this time, the pressure inside the molding cavity 110a is in the pressurized state. Therefore, bubble nuclei N formed by the supercritical fluid in the material M inside the mold can be prevented from foaming.

After a predetermined period of time following injection of the material M into the molding cavity 110a by the injection device 120, when the surface of the material M injected into the mold 110 is cooled off and solidified, the gas supply device 130 stops supplying the gas to stop increasing the pressure of the molding cavity by the gas supply device 130. In addition, the movable portion 114 shown in FIG. 2C is moved relative to the fixed portion 112 to the position shown in FIG. 2D to increase the volume of the molding cavity 110a. In this way, the pressure inside the molding cavity 110a is restored to the non-pressurized state. Hence, the bubble nuclei N formed by the supercritical fluid in the material M start foaming as the pressure decreases, and a plurality of bubbles B are formed. In this way, a defect generated on the surface of the material M in a non-solidified state due to foaming of the supercritical fluid is avoided, and the foaming of the supercritical fluid is uniform. Thus, the products manufactured accordingly have a desirable quality and yield.

In other embodiments, when the pressure inside the molding cavity 110a is restored from the pressurized state to the non-pressurized state, depending on the product size as needed, it may be unnecessary to fully restore the movable portion 114 to the position shown in FIG. 2D. Instead, the movable portion 114 may be moved to a suitable position between the position shown in FIG. 2C and the position shown in FIG. 2D, so as to control the product size. Also, in other embodiments, the movable portion 114 may be firstly moved leftward to increase the volume of the molding cavity 110a, so that the material M may have an increased moldability and form a plurality of bubbles through foaming due to a smaller pressure when the material M is injected to the molding cavity 110a. Then the movable portion 114 is moved rightward to compress the material, so that the bubbles are connected with one another to form a through hole, thereby changing the elasticity of the product.

In other embodiments, the pressure inside the molding cavity 110a may be changed only by moving the movable portion 114 or only by supplying the gas by the gas supply device 130 or not. It should be noted that the invention does not intend to impose a limitation on this regard. Regarding this, examples are described in the following with reference to the drawings.

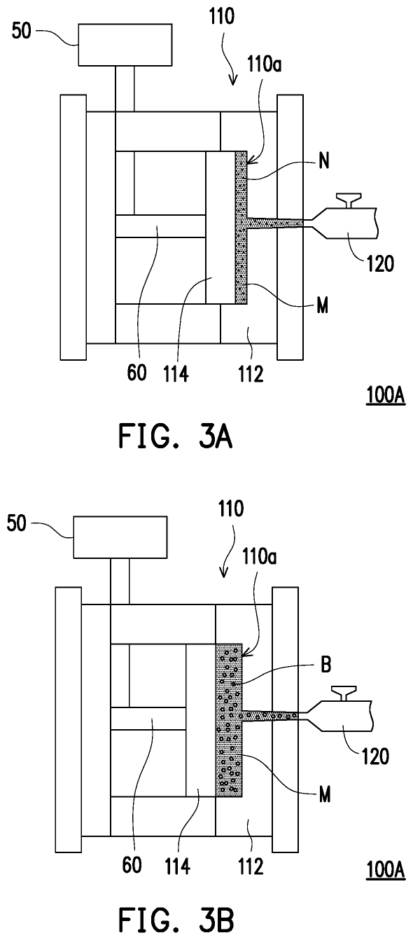

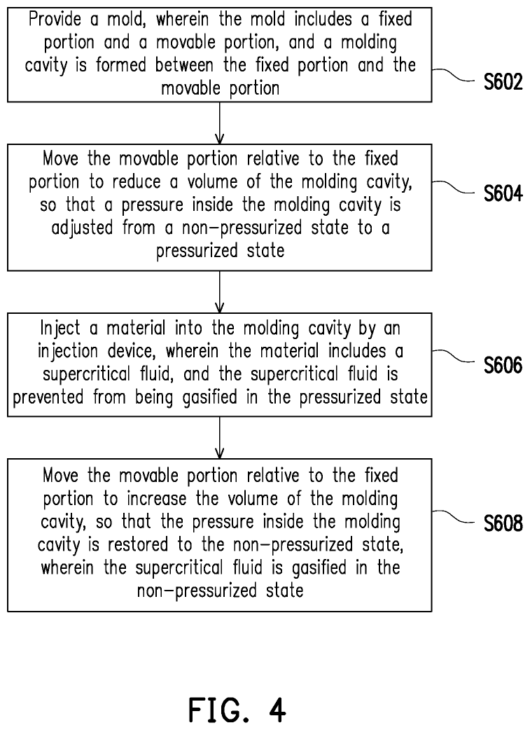

FIG. 3A and FIG. 3B are views illustrating an operational process of an injection molding apparatus according to another embodiment of the invention. FIG. 4 is a flowchart illustrating an injection molding method of the injection molding apparatus of FIGS. 3A and 3B. An injection molding apparatus 100A shown in FIGS. 3A and 3B differs from the injection molding apparatus 100 shown in FIGS. 1 and 2A to 2D in that, in the embodiment shown in FIGS. 3A and 3B, the pressure inside the molding cavity 110a is changed only by moving the movable portion 114. The operational process is similar to the operational process of the movable portion 114 in the embodiment shown in FIGS. 1 and 2A to 2D. Details in this regard are described in the following with reference to FIG. 4. Firstly, the mold 110 is provided. The mold 110 includes the fixed portion 112 and the movable portion 114. The molding cavity 110a is formed between the fixed portion 112 and the movable portion 114 (Step S602). Then, the movable portion 114 is moved relative to the fixed portion 112 to the state shown in FIG. 3A to reduce the volume of the molding cavity 110a, so that the pressure inside the molding cavity 110a is adjusted from the non-pressurized state to the pressurized state (Step S604). The material M is injected into the molding cavity 110a by the injection device 120. The material M includes a supercritical fluid. The supercritical fluid is prevented from being gasified in the pressurized state shown in FIG. 3A (Step S606). The movable portion 114 is moved relative to the fixed portion 112 to increase the volume of the molding cavity 110a as shown in FIG. 3B, so that the pressure inside the molding cavity 110a is restored to the non-pressurized state. In addition, the supercritical fluid is gasified and starts foaming in the non-pressurized state shown in FIG. 3B.

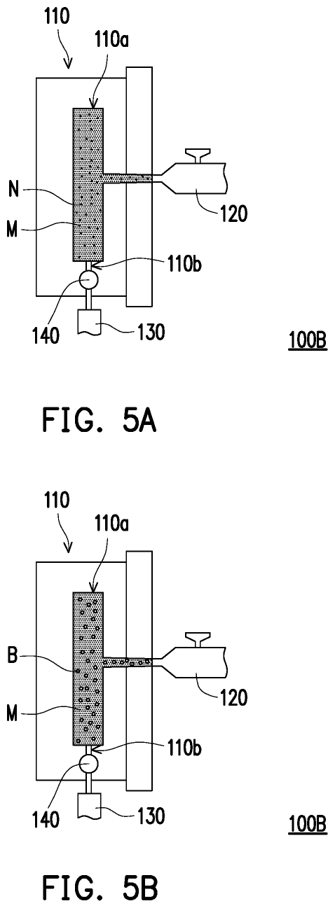

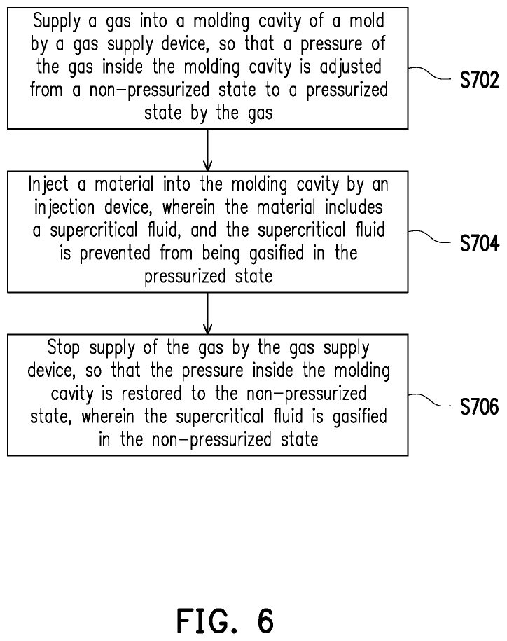

FIG. 5A and FIG. 5B are views illustrating an operational process of an injection molding apparatus according to another embodiment of the invention. FIG. 6 is a flowchart illustrating an injection molding method of the injection molding apparatus of FIGS. 5A and 5B. An injection molding apparatus 100B shown in FIGS. 5A and 5B differs from the injection molding apparatus 100 shown in FIGS. 1 and 2A to 2D in that, in the embodiment shown in FIGS. 5A and 5B, the pressure inside the molding cavity 110a is changed only by supplying the gas by the gas supply device 130 or not. The operational process is similar to the operational process of the gas supply device 130 in the embodiment shown in FIGS. 1 and 2A to 2D. Details in this regard are described in the following with reference to FIG. 6. Firstly, the gas is supplied by the gas supply device 130 to the molding cavity 110a of the mold 110, so that the pressure inside the molding cavity is adjusted by the gas from the non-pressurized state to the pressurized state (Step S702). Then, the material M is injected into the molding cavity by the injection device 120. The material M includes a supercritical fluid. The pressurized state shown in FIG. 5A prevents the supercritical fluid from being gasified (Step S704). The gas supply device 130 stops supplying the gas, so that the pressure inside the molding cavity 110a is restored to the non-pressurized state. The non-pressurized state shown in FIG. 5B allows the supercritical fluid to be gasified and start foaming (Step S706).

In view of the foregoing, in the embodiments of the invention, before the material is injected into the mold, the gas supply device supplies the gas into the molding cavity to increase the pressure inside the molding cavity, and/or the movable portion of the mold is moved to increase the pressure inside the molding cavity. In this way, the supercritical fluid in the material injected into the mold is prevented from foaming. After the surface of the material injected into the mold is cooled off and solidified, the gas supply device no longer increases the pressure inside the molding cavity, so that the bubble nuclei formed in the supercritical fluid in the material start foaming as the pressure decreases. In this way, a defect generated on the surface of the material in a non-solidified state due to foaming of the supercritical fluid is avoided, and the foaming of the supercritical fluid is uniform. Thus, the products manufactured accordingly have a desirable quality and yield.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An injection molding apparatus, comprising:
a mold, comprising a fixed portion and a movable portion, wherein a molding cavity is formed between the fixed portion and the movable portion, the movable portion is adapted to move relative to the fixed portion to change a volume of the molding cavity, such that a pressure inside the molding cavity is adjusted between a non-pressurized state and a pressurized state; and
an injection device, adapted to inject a material into the molding cavity, wherein the material comprises a supercritical fluid, the supercritical fluid is prevented from being gasified in the pressurized state, and the supercritical fluid is gasified in the non-pressurized state.

2. The injection molding apparatus as claimed in claim 1, further comprising a gas supply device, wherein the gas supply device is adapted to supply a gas into the molding cavity to increase the pressure inside the molding cavity.

3. The injection molding apparatus as claimed in claim 2, wherein the mold has a gas injection passage, the gas injection passage connects interior of the molding cavity and exterior of the molding cavity, and the gas supply device is adapted to supply the gas into the molding cavity via the gas injection passage.

4. The injection molding apparatus as claimed in claim 3, further comprising a pressure sensor, wherein the pressure sensor is disposed to the gas injection passage.

5. An injection molding method, comprising:
providing a mold, wherein the mold comprises a fixed portion and a movable portion, and a molding cavity is formed between the fixed portion and the movable portion;
moving the movable portion relative to the fixed portion to reduce a volume of the molding cavity, such that a pressure inside the molding cavity is adjusted from a non-pressurized state to a pressurized state;
injecting a material into the molding cavity by an injection device, wherein the material comprises a supercritical fluid, and the supercritical fluid is prevented from being gasified in the pressurized state; and
moving the movable portion relative to the fixed portion to increase the volume of the molding cavity, so as to restore the pressure inside the molding cavity to the non-pressurized state, wherein the supercritical fluid is gasified in the non-pressurized state.

6. The injection molding method as claimed in claim 5, further comprising supplying a gas into the molding cavity by a gas supply device to increase the pressure inside the molding cavity.

7. The injection molding method as claimed in claim 6, wherein after the gas is supplied into the molding cavity of the mold, the material is injected into the molding cavity by the injection device.

8. The injection molding method as claimed in claim 6, wherein after a predetermined period of time following injection of the material into the molding cavity by the injection device, the gas supply device stops supplying the gas.

9. The injection molding method as claimed in claim 5, wherein after the movable portion is moved relative to the fixed portion to reduce the volume of the molding cavity, the material is injected into the molding cavity by the injection apparatus.

10. The injection molding method as claimed in claim 5, wherein after a predetermined period of time following injection of the material into the molding cavity by the injection device, the movable portion is moved relative to the fixed portion to increase the volume of the molding cavity.
